(19) United States
(12) Patent Application Publication
(10) Pub. No.: US 2011/0107826 A1
(43) Pub. Date: May 12, 2011

(54) APPARATUS AND METHOD FOR MASS AIR MEASURING

(76) Inventor: Douglas E. Wallis, Walhalla, SC (US)

(21) Appl. No.: 12/734,837

(22) PCT Filed: Nov. 26, 2008
(86) PCT No.: PCT/US2008/013155

§ 371 Date: Jan. 14, 2011

Related U.S. Application Data
(60) Provisional application No. 61/004,281, filed on Nov. 26, 2007.

(51) Int. Cl. G01M 15/00

(52) U.S. Cl. 73/114.32

(57) ABSTRACT

The present invention is designed to measure air mass flow for fuel injection applications, by utilizing a digital signal processor as part of the air measuring device's circuitry so that calibration tables associated with various engine types may be loaded into the processor. The digital signal processor stores a plurality of calibration tables for various engine types onboard. These may be chosen through the use of an external programming device or an onboard selection device such as a switch. The digital signal processor will convert output into either voltage or frequency outputs depending on the requirements of the particular engine control unit.

### PRIOR APPLICATIONS

This application claims the benefit of earlier filed U.S. Provisional Application 61/004,281 filed Nov. 26, 2007.

### TECHNICAL FIELD

In internal-combustion engines, combustion is achieved by the confluence of air, fuel and an ignition source, usually in the form of a spark. Since internal-combustion engines operate at various speeds, the amount of fuel and air delivered to the combustion chamber must vary. A mechanism for measuring and delivering the proper air mass and fuel mass is necessary in order to achieve the correct ratio of air and fuel to approach the stoichiometricly ideal air/fuel mix of 14.64:1, so that the fuel may be combusted completely or otherwise combusted for maximum performance. Various methods of measuring and delivering the proper air mass have been developed over time. Initially, carburetors were developed which were largely mechanical devices based on Bernoulli's principal where as air flow increased and the air pressure dropped, more fuel was drawn into the mixture. This was followed in the 1980's by electronic fuel injection systems that used a number of sensors and inputs including the measure of air mass to determine the amount of fuel delivered to the combustion chamber. Other methods of measuring air mass have been employed and then phased out based on improving technology. Two examples are the Vane Air Flow Meter (VAFM) and the Karman Vortex Air Flow Meter (AFM). This metering allowed only indirect measures of air mass. Hot wire and hot film mass air flow sensors, which represent the current technology, directly measure air mass. Hot wire and hot film sensors operate in a similar fashion. Constant voltage is applied to the sensor which is positioned in the inlet air stream. Air flows across the sensor. Since the sensor is a positive temperature coefficient (ptc) resistor, as it cooled, its resistance drops. The drop in resistance allows an increased current flow which in turn maintains the preset temperature of the sensor. The measure of the current is then sent to a computer and it is transformed into a measure of air flow.

### DISCLOSURE OF THE INVENTION

The current technology represents mass air measuring devices that offer a static design. The control unit of mass air measuring devices are set at a particular reference voltage, for example 5V. When an engine is at idle, the mass air measuring device may return from 0.4V to 0.5V and when the engine is operated with the throttle wide open, the return may be in the 4.5V to 5V range. A particular reference voltage of 5V may, for example, correspond to 500 kg of air flow. The air flow equivalent to a particular reference voltage is hardwired into the circuitry of the mass air measuring device. Thus, a particular mass air measuring device manufactured using current technology is suitable for only one application on one type of engine.

In order to change the reference voltage it is necessary to laser trim the circuit. Laser trimming is a manufacturing process used to adjust the operating parameters of a circuit. In this case, it is used to alter the attributes of the resistors in the mass air measuring device. The laser is used to burn away a small portion of a resistor thus raising the resistor's value. After the circuitry is modified, it still is suitable for only a single application.

It is an object of this invention to utilize a digital signal processor as part of the air measuring device's circuitry so that calibration tables associated with various engine types may be loaded into the processor and based on the calibration table, reference voltages may be set to correspond with various levels of air flow by user input through an external programming device such as a computer. Calibration tables for various engine types contain data points that relate various input voltages to air mass or flow oftentimes measured in kg per hour. The tables also translate a given air mass or flow to output in either voltages or frequency which are then transmitted to the engine control unit.

Another object of this invention is to utilize the digital signal processor to store a plurality of calibration tables for various engine types onboard. These may be chosen through the use of an external programming device or an onboard selection device such as a switch.

Another object of this invention is to utilize the digital signal processor to convert output into either voltage or frequency outputs. An engine control unit (ECU), used in automobiles, controls various aspects of an engines operation such as the quantity of fuel injected, ignition timing, and other parameters. Some ECUs expect voltage input examples of which can be seen in the discussion in the first paragraph of this section. However, some ECUs expect frequency input.

Hot wire sensors use a platinum wire or filament heated to predetermined temperature. When the incoming air stream flows over the sensor, the wire cools. The electrical principal that resistance varies with temperature is applied here. As the wire cools, there is a measurable drop in resistance and higher current is required to maintain the predetermined temperature. The current differential is then used to measure air mass.

In hot film sensors, one side or upstream leg of the sensor encounters the cooling air flow while the second side or downstream leg of the sensor does not. This causes what is termed an unbalanced bridge. The unbalanced resistance requires current to rebalance the bridge. The current differential between the upstream and downstream legs of the sensor is then used to measure air flow.

Both the hot wire or hot film mass air sensors that use the cooling capacity of incoming air suffer from time lag in determining air mass measure. It takes a measure of time for the sensor to cool and a measure of time for resistance to drop and for current to increase. Thus, the measure of air flow may lag behind the actual thermal response of the sensors.

It is an object of this invention to resolve this time lag by employing a transition filter. The term “transition” as used here refers to a sudden transition in the amount of air flow, for example, when an engine is quickly throttled up. The transition filter is composed of a digital gain amplifier that is capacitivly coupled to the leading sensor array. The transition filter is then electrically connected to the analog input of the digital signal processor. The capacitive coupling will only pass a signal that has a different voltage potential. Thus, if there is a steady state air flow, the capacitivly coupled digital gain amplifier passes no information to the digital signal processor. However, if there is a quick pulse of air flow, the transition filter passes this information to the digital signal processor that then takes the pulse into the air flow calculation.

Another object of this invention is to use the digital signal processor to employ averaging algorithms or averaging filters and difference filters to average the large number of readings provided by the mass air sensors. This offers the added advantage of cleaning the signal by removing spikes and other anomalies.

Another object of this invention is to store a baseline calibration table in the digital signal processor. The standard manufacturing process of mass air measuring devices introduces some variation in output values. The mass air meter is placed on a precision flow stand where its output is measured. The baseline calibration table is loaded into the individual meter's digital signal processor and the meter is then given a baseline so that all meters give consistent readings.

Another object of this invention is the use of a digitally controlled operational amplifiers (DCOA). This allows the lower flow calibrations to use the 0-5V inputs of the digital signal processor analog convertor.

### BRIEF DESCRIPTION OF THE DRAWINGS

FIG. 1 is a flow chart of the method of processing mass air data.

FIG. 2 is a flow chart of the balanced bridge analog

FIG. 3 is an end view of the trailing sensor support blade.

FIG. 4 is an end view of the leading sensor support blade.

FIG. 5 is a plan view of the mass air measuring device.

FIG. 6 is a perspective view of the first and second sensor support blades.

### BEST MODE FOR CARRYING OUT THE INVENTION

For the purpose of this specification the use of the term “engine” as used here and in the claims may be considered any device wherein air flow may be measured. The term “air” for the purpose of this specification means any gas or fluid. “Transition” as used here and in the claims represents a change in air flow.

Turning first to FIG. 5 the mass air measuring apparatus can be seen. The two primary components of the device are the flow housing 1 and the digital signal processor housing 48. The flow housing is composed of flow housing wall 2 which encloses the air flow channel 3. It is important to note that the air flow channel allows complete air flow through the device. Mounted to the flow housing wall 2 and within the air flow channel 3 is the first sensor mounting blade 4 and second sensor mounting blade 5. Each of these sensor mounting blades exhibit a plurality of mounting connectors 55. It should be noted that the sensor mounting blades may assume the form of circuit boards and consequently the mounting connectors may be electrically connected to the sensor mounting blades. The mass air sensors are mounted between the pairs of mounting connectors and are electrically connected to the mounting connectors 55. The mass air sensors are not mounted flush against the sensor mounting blades but are connected to the mounting connectors distal to the sensor mounting blade surface so that a quantum of air flow can be achieved between the mass air sensor and the sensor mounting blade. However the mass air sensor is not located so far distal to the sensor mounting blade as to remove it from shielding of reverse air flow by virtue of the sensor mounting blades displacement.

First sensor mounting blade 4 is considered the leading sensor blade. Second sensor mounting blade 5 is considered trailing and rests below sensor mounting blade 4. Sensor mounting blade 4 and sensor mounting blade 5 are mounted to the flow housing wall 2 at 90 degrees to one another thus dividing the air flow channel 3 into four substantially equal quadrants. Further as can be seen from FIG. 5, the mass air flow sensors are located approximately midway between the vertical center axis of the sensor mounting blade and their ends. First sensor mounting blade 4 makes contact with the flow housing wall 2. The electrical contacts which connect the mass air sensors in parallel to one another extend through flow housing wall 2 and into digital signal processor housing 48. There, first mass air sensor 12 and second mass air sensor 13 mounted on first sensor mounting blade 4 are electrically connected to the digital signal processor 26 and to transition filter 27. Third mass air sensor 15 and forth mass air sensor 16 again are mounted electrically parallel to the second sensor mounting blade 5. They also have their electrical connections pass through second sensor mounting blade 5 and through flow housing wall 2 entering into digital signal processing housing 48 and connecting directly to digital signal processor 26. Also shown in FIG. 5 is port 56 which is a connector for an external programming device.

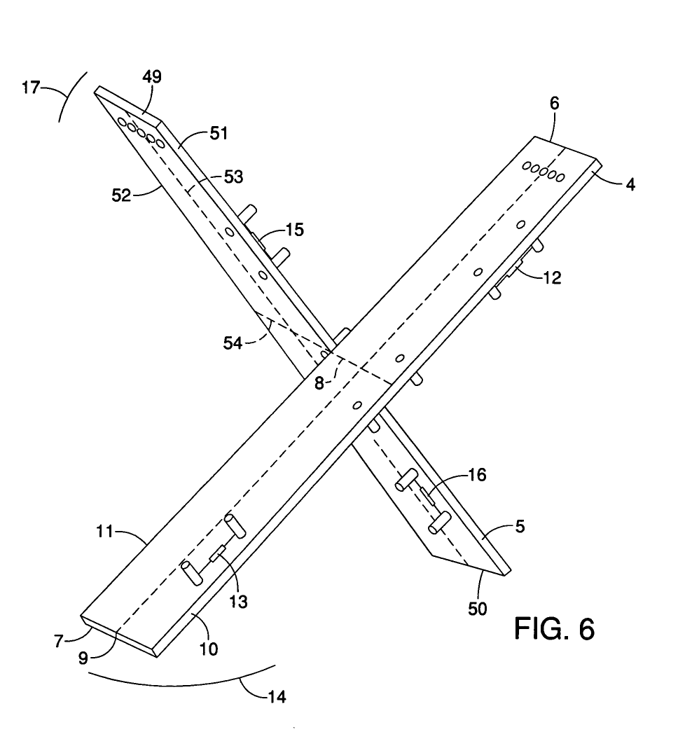

Turning now to FIG. 6 which shows additional detail for the sensor mounting blades. Leading sensor array 14 is composed of first sensor mounting blade 4 in combination with first mass air sensor 12 and second mass air sensor 13. Leading array 14 is mounted within air flow channel 3 such that it encounters incoming air first. First sensor mounting blade 4 exhibits first sensor mounting blade first end 6 and first sensor mounted blade second end 7. Centered between these ends is first sensor mounting blade vertical center axis 8. First sensor mounting blade 4 also exhibits a first sensor mounting blade leading edge 10 and first sensor mounting blade trailing edge 11. Centered between the leading edge and trailing edge first sensor mounting blade longitudinal center axis 9. Also illustrated in FIG. 6 is the trailing sensor array 17 which is composed of the first sensor mounting blade 4, third mass air sensor 15 and fourth mass air sensor 16. Second mass air sensor mounting blade 5 also exhibits second sensor mounting blade first end 49 and second sensor mounting blade second end 50. Centered between the first and second ends, the second sensor mounting blade vertical center axis 54 is illustrated. Second sensor mounting blade 5 also exhibits second sensor mounting blade leading edge 51 and second sensor trailing edge 52. Centered between is second sensor mounting blade longitudinal center axis 53.

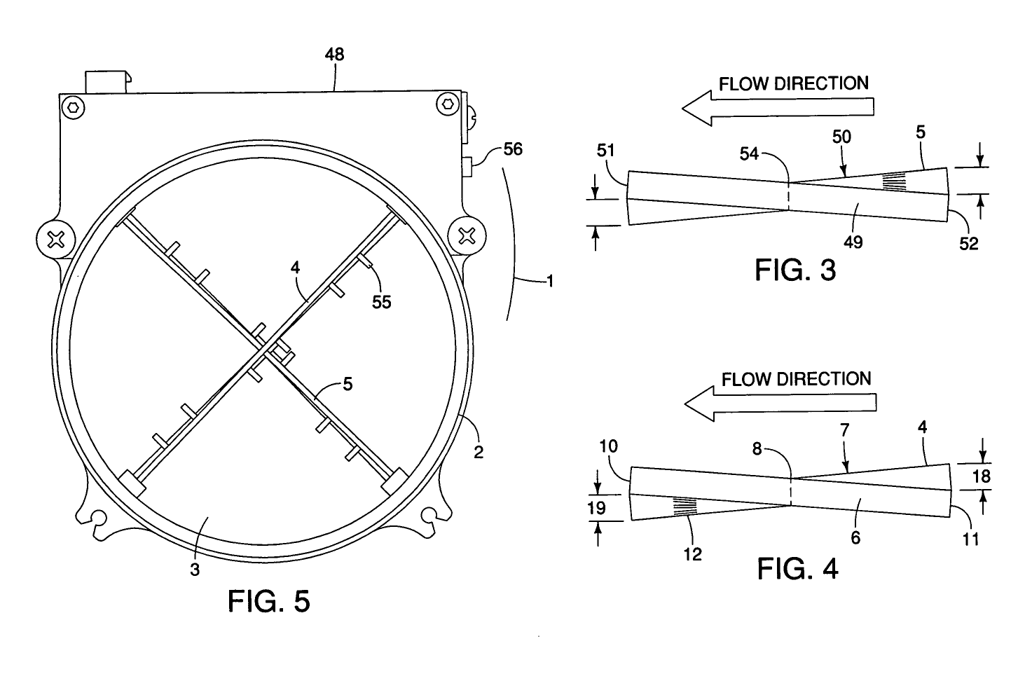

Turning now to FIG. 3 we see a side view of second sensor mounting blade 5. Here we see second sensor mounting blade longitudinal center axis 53. Also illustrated is second sensor mounting blade first end 49 and second sensor mounting blade second end 50 as well as second sensor mounting blade leading edge 51 and second sensor mounting blade trailing edge 52. FIG. 3 is designed to illustrate second sensor mounting first displacement 22 and second sensor mounting blade second displacement 23. As illustrated in FIG. 3 second sensor mounting blade second end along with a portion of second sensor mounting blade trailing edge 52 is displaced away from the second sensor mounting blade longitudinal center axis 53. This displacement is enough to allow the third mass air sensor to be shrouded from any reverse flow which may be encountered. Second sensor mounting blade second displacement 23 is also illustrated here. Since second sensor mounting blade leading edge 51 is displaced away from second sensor mounting blade longitudinal center axis 53 in a direction opposite that of the second sensor mounting blade first displacement 22 this provides what may be described as a twist to the sensor mounting blade, again allowing the mass air sensors to be shrouded from a reverse flow.

FIG. 4 illustrates the first sensor mounting blade 4. FIG. 4 shows substantially the same components as FIG. 3 and first sensor mounting blade first displacement 18 is shown as well as first sensor mounting blade second displacement 19 and relative position of first air mass sensor 12.

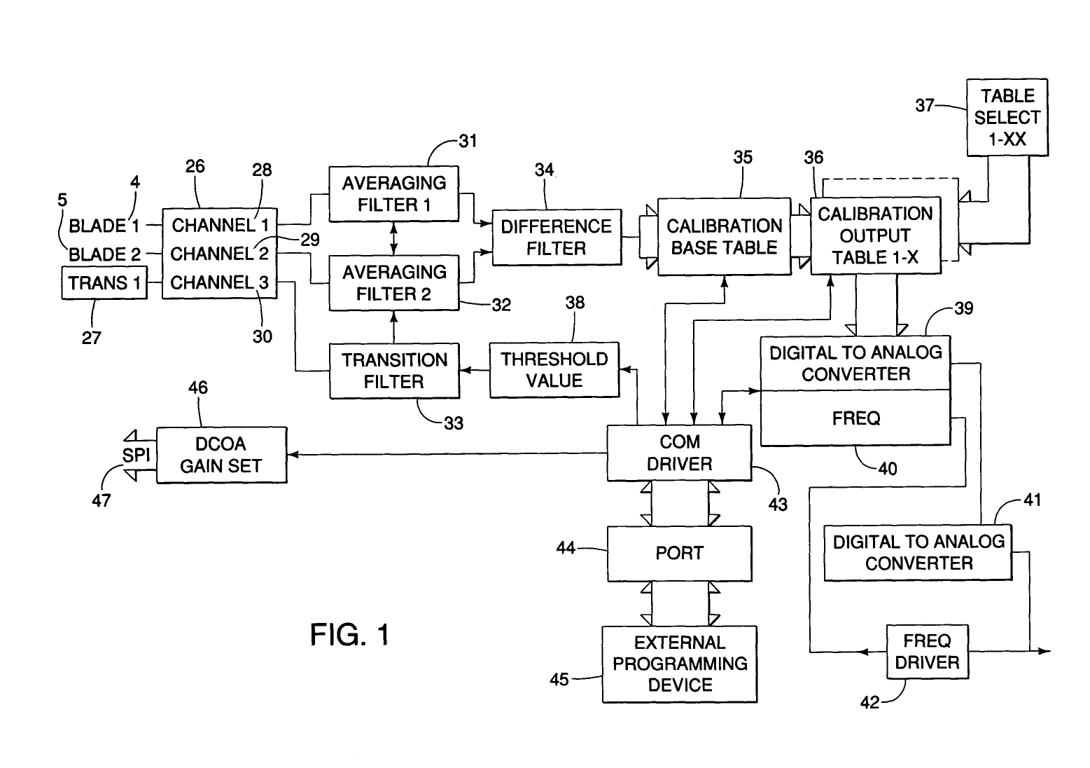

Turning now to FIG. 1 which illustrates the mass air data processing method, we see that the mass air quantity reading from first mass air sensor 12 and second mass air sensor 13 wired in parallel are transmitted from first sensor mounting blade 1 represented by “Blade 1” 4 on FIG. 1. The data is transmitted to analogue to digital “Channel 1” 28 internal to digital signal processor 26. The mass air quantity readings are then transmitted within the digital signal processor 26 to the “averaging filter 1 algorithm” 31. “Averaging filter 1 algorithm” 31 is designed to accept a predetermined and programmable number of discrete readings from the leading sensor array 14. When the predetermined number of readings has been achieved, those values are averaged and then compared to the next received air quantity reading. Those are again averaged. A similar concept is seen with second sensor mounting blade 5 input represented by “Blade 2” in FIG. 1. The readings from trailing sensor array 17 are transmitted to digital signal processor 26 through analogue to digital “Channel 2.” Again after a programmable but predetermined number of readings have been taken, the readings are then averaged and then compared again and averaged with the next succeeding reading. This takes place within the digital signal processor by the “Averaging filter 2 algorithm” 32. The readings from “Averaging filter 1 algorithm” 31 and “Averaging filter 2 algorithm” 32 are also averaged. This data is transferred to a “difference filter algorithm” 34.

Because mass air sensors of the hot film or hot wire design either which may be used is the present invention, use the cooling capacity of incoming air, they provide an actual thermal response which may lag behind the true measure of air flow. In order to compensate for this thermal response lag the data stream from the leading sensor array is not only directly provided to the analogue to digital “Channel 1” 28 within digital signal processor 26 but it is also transmitted through a transition filter 27 designated by “Trans 1” in FIG. 1. The transition filter 27 is composed of a digital gain amplifier that is capacitivly coupled. The purpose of the digital gain amplifier is self explanatory however the fact that it is capacitivly coupled will allow the amplified signal to pass only if it has a different voltage potential as determined by the leading sensor array. Thus if there is a steady air flow the capacitivly coupled digital gain amplifier passes no information through to digital signal processor 26. However when the engine is quickly throttled up, a different voltage potential will be read and the transition filter 27 then passes this information to the digital signal processor 26 through the analogue to digital “Channel 3” 30. This information is then transmitted to the transition filter algorithm 33 within the DSP. If the transition filter algorithm 33 returns a value greater than a predetermined and/or preprogrammed threshold value 38 the values are then utilized in the averaging processes as seen in “Averaging filter 1 algorithm” 31 and “Averaging filter 2 algorithm” 32.

The data from the combined averaging filter 2 algorithm 31 and averaging filter 1 algorithm 32 and Transition Filter 33 is then transmitted through Calibration base table 35. The calibration base table 35 is data that is loaded into each individual meters digital signal processor to compensate for differences in readings which may have resulted from the manufacturing process. The calibration base data table which then provides a base line so that all meters irrespective of anomalies in manufacturing processes, will give consistent output. The data is then transmitted and read through Calibration output tables 36. Each calibration output table is specific to a particular engine type. The number of calibration output table and therefore the number of engines that this mass air measuring device may be adapted to work with is limited only by the size of the DSP memory.

The particular calibration output table may be chosen in two ways. It may be chosen by an onboard hard wired switch which is represented by Table Select 37 in FIG. 1. Or it may be chosen by utilizing an external programming device 45 connected to the digital signal processor port 44. Port 44 may be a number different configuration such as serial or USB. Com Driver 43 will be available within the DSP to accommodate any number of Port types. As shown, threshold value 38 and calibration base table 35 may both be modified by the external programmer 45 but most importantly the particular calibration output table 36 can also be chosen or modified by an external programming device.

Some engine control units are designed to accept frequency outputs from the air mass sensors while other engine types are designed to receive voltage outputs. The data after being put through the calibration output table 36 can then be transmitted to a digital to analogue converter 39 which produces a frequency signal 40 or the output may be shunted to a digital to analogue converter 41 where the output is measured in volts. As shown in FIG. 1, the determination of frequency output or voltage output may be controlled by the external programming device 45. After the determination of either frequency or voltage output, the signal is then sent to the particular engine control unit where based on the air mass measure, a quantity of fuel necessary to achieve the stoichiometricly correct air fuel fixture of 14.46:1 is then injected into the combustion chamber.

FIG. 1 also illustrates a digitally controlled operational amplifier 46. The use of the digitally controlled operational amplifier 46 allows the dynamic range of the sensor arrays to be amplified so that lower flow calibrations can still use the full range of the 0 to 5 volt inputs of the digital processor 26 analogue to digital converter. The digitally controlled operational amplifier 46 can have its gain set by the digital signal processor 26 that has value stored internally and that are provided from an external programming device.

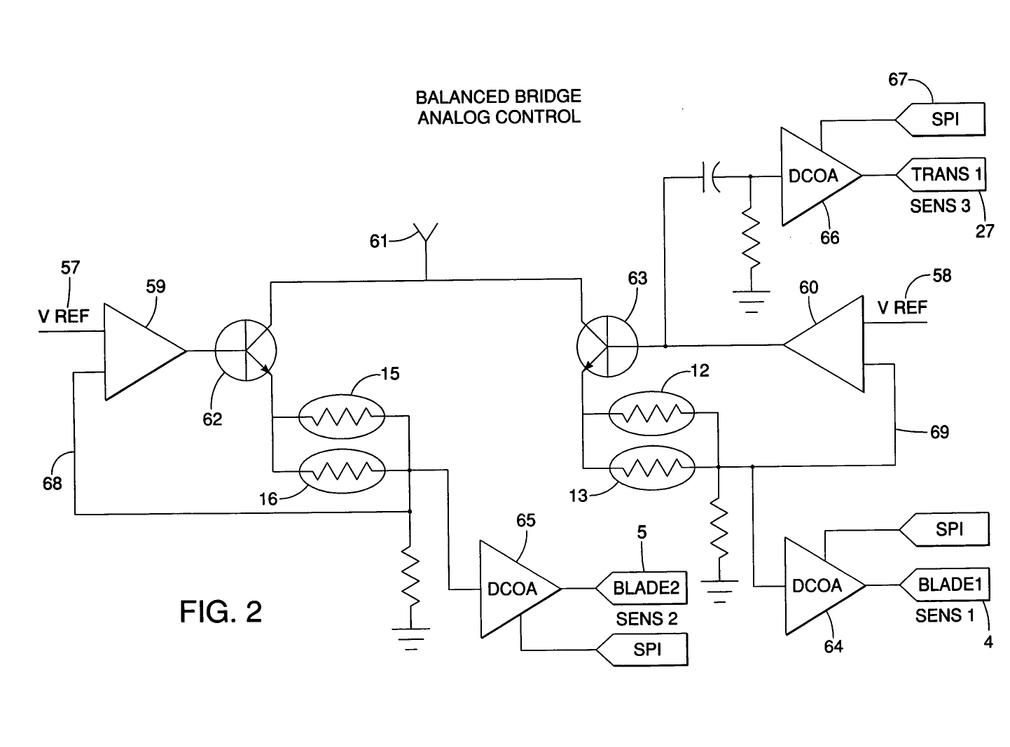

Turning to FIG. 2 we see the balanced bridge analogue control mechanism. This is composed of first voltage reference 57. First voltage reference 57 is composed of a pair of resistors that create a particular voltage. This particular voltage is set internally to correspond with a temperature at which the mass air sensors, in this case third mass air sensor 15 and fourth mass air sensor 16 should operate at steady state conditions. For example the voltage generated by voltage reference 57 could be set to correspond with a temperature of 300 degrees above ambient temperature. Naturally ambient air temperature will need to be measured and inputted into the system. When air flows past third mass air sensor 15 and fourth mass air sensor 16, they are cooled and drop below their steady state temperature of 300 degrees above ambient air. The cooling causes a change in resistance of the mass air sensors. This sent to the operational amplifier through first resistance input loop 68. First resistor 62 then allows additional current to flow to third mass air sensor 15 and fourth mass air sensor 16 until they re-establish their temperatures at the steady state of 300 degrees above ambient temperature. The output from the balanced bridge circuitry is then inputted into a digitally controlled operational amplifier 1. The output of first digitally controlled operational amplifier 65 is then fed into the analogue input of the digital signal processor here represented by “blade 2” 5. Within the digital signal processor these analog inputs are converted to a 12 bit signal. The digital signal has a range of 0 to 5 volts divided by 12 bits or 4096. This produces a step voltage of 5 volts divided by 4096 or 0.0012 volts per step. The gain and consequently the alteration of the range can be set within the digitally controlled operational amplifier by the digital signal processor which in turn can be programmed from the external programming device 45. A similar balance bridge configuration is used for the leading sensor array composed of first mass air sensor 12 and second mass air sensor 13. Here second voltage reference 58 is inputted into second operational amplifier 60. Those readings are then sent through second transistor 63 and onto first mass air sensor 12 and second mass air sensor 13.

The output data is then sent to first digitally controlled operational amplifier 64 and then onto the digital signal processor through first sensor mounting blade 4 represented by “blade 1” on FIGS. 2 and 1. The use of digitally controlled operational amplifiers allows the dynamic range of the bridge circuit to be amplified so that lower flow calibrations can still use the full range of the zero to five volt input of the digital signal processor analogue converters. For example if the full dynamic range of the balance bridge circuit is zero to four thousand kilograms of air, and the particular application for an engine type only requires zero to one thousand kilograms of air, the digitally controlled operational amplifier will compensate for this difference in range. The analog to digital converter would divide the 0-4 kg into 4096 parts only leaving 1024 parts to be used in the 0-1000 kg output. By using the digitally controlled operational amplifier, the analog signal can be multiplied to reach the 5 v rail earlier such as 0-1000 kg before being divided by the 4096 using the full range of the analog to digital converter. This is set in software instead of changing resistors as in the existing analog designs.

### INDUSTRIAL APPLICABILITY

This invention is suitable for applications in industry where accurate air flow measurements are required. Specifically where accurate air flow measurements are necessary in order to mix a measured quantity of air with a measured quantity of fuel in proper ratios, as more particularly seen in electronic fuel injection systems of automobiles. This invention is also suitable for adapting a single mass air measuring apparatus for use on various engine types through software modifications generated by user input.

What is claimed is:

1. An apparatus for measuring air intake of an engine comprising:
a flow housing said flow housing further comprising an air flow channel therethrough,
a flow housing wall,
a plurality of sensor mounting blades mounted within said air flow channel and mounted to said flow housing wall, said plurality of sensor mounting blades each having a first end and a second end, a vertical center axis therebetween, a leading edge and a trailing edge said leading edge orientated toward the direction of incoming air, said trailing edge orientated toward the direction of reverse flow air, a longitudinal center axis between said leading edge and said trailing edge,
a plurality of air mass sensors mounted on said plurality of sensor mounting blades,
said plurality of air mass sensors capable translating air flow quantity into digital frequency outputs;
a digital signal processor electrically connected to said plurality of air mass sensors, whereby said digital frequency outputs are averaged.

2. The apparatus for measuring air intake of an engine of claim 1 wherein the plurality of sensor mounting blades is at least two in number further comprising a first sensor mounting blade and a second sensor mounting blade,
further wherein the plurality of air mass sensors are at least four in number further comprising a first air mass sensor, a second air mass sensor, a third air mass sensor and a fourth air mass sensor.

3. The apparatus for measuring air intake of an engine of claim 2 wherein said first mass air sensor and said second mass air sensor are mounted on said first sensor mounting blade forming a leading sensor array, said first mass air sensor and said second mass air sensor electrically connected in parallel, further wherein said third sensor mass air sensor and said fourth mass air sensor are mounted on said second sensor mounting blade forming a trailing sensor array, said third mass air sensor and said fourth mass air sensor electrically connected in parallel.

4. The apparatus for measuring air intake of an engine of claim 3 wherein said first sensor mounting blade bisects said air flow channel, further wherein said second sensor mounting blade bisects said air flow channel at 90 degrees to said first sensor mounting blade, said trailing edge of said first sensor mounting blade in contact with said leading edge of said second sensor mounting blade said first sensor mounting blade mounted within said air flow channel proximal to the direction of incoming air.

5. The apparatus for measuring air intake of an engine of claim 4 wherein said first sensor mounting blade exhibits a first displacement of said leading edge away from said longitudinal center line, said first displacement originating at said first end and terminating at said vertical center line, a second displacement of said leading edge away from said longitudinal center line, said second displacement in an opposing direction from said first displacement, originating at said second end and terminating at said vertical center line, a third displacement of said trailing edge away from said longitudinal centerline in a direction opposing said first displacement, originating at said first end and termination at said vertical centerline; a fourth displacement of said trailing edge away from said longitudinal centerline in a direction opposing said second displacement, originating at said first end and termination at said vertical centerline, said displacements shrouding said first mass air sensor and said second mass air sense from said reverse air flow.

6. The apparatus for measuring air intake of an engine of claim 4 wherein said second sensor mounting blade exhibits a first displacement of said leading edge away from said longitudinal center line, said first displacement originating at said first end and terminating at said vertical center line, a second displacement of said leading edge away from said longitudinal center line, said second displacement in an opposing direction from said first displacement, originating at said second end and terminating at said vertical center line, a third displacement of said trailing edge away from said longitudinal centerline in a direction opposing said first displacement, originating at said first end and termination at said vertical centerline; a fourth displacement of said trailing edge away from said longitudinal centerline in a direction opposing said second displacement, originating at said first end and termination at said vertical centerline, said displacements shrouding said second mass air sensor and said third mass air sensors from said reverse air flow whereby said reverse air flow is prevented from being detected.

7. The apparatus for measuring air intake of an engine of claim 1 whereby multiple mass air flow readings are taken from differing areas of said air flow channel.

8. The apparatus for measuring air intake of an engine of claim 3 wherein said first, second, third and fourth mass air sensors are mounted above the surface of said first and second sensor mounting blades permitting the air to flow between said mass air sensors and said sensor mounting blades.

9. The apparatus for measuring air intake of an engine of claim 1 further comprising,
a transition filter electrically connected to said leading array,
a digital signal processor connected to said transition filter.

10. The transition filter of claim 9 comprising a capacitive coupled digital gain amplifier whereby steady state signals are not passed through to the digital signal processor and whereby transitions are amplified and passed through to the digital signal processor.

11. The apparatus for measuring air intake of an engine of claim 1 further comprising, a communications port whereby an external programming device may communicate with said digital signal processor.

12. The digital signal processor of claim 1 further comprising a plurality of calibration tables which allow said apparatus for measuring air intake of an engine to be utilized for more than one engine type.

13. The apparatus for measuring air intake of an engine of claim 1 further comprising, an onboard selection device whereby said plurality of calibration tables may be chosen.

14. A method for measuring air mass intake of an engine comprising;
an air mass measuring step wherein air mass measures are received from a plurality of said air mass sensors composed of two individual arrays using a hot wire type flow sensor or a hot film type flow sensor, each array using a balancing circuit whereby the temperature of said air mass sensors is programmably set to a steady state temperature above ambient air temperature, ambient air temperature measured by other sensors, and wherein air moving past said air mass sensors cools said air mass sensors altering their resistance and wherein said balancing circuit provides increased current to return said mass air sensors to their steady state temperature said current outputted to said digital signal processor in analog form,
an analog signal to digital signal conversion step wherein said analog signals from two individual arrays of air mass sensors are converted within said digital signal processor to digital signals,
a signal averaging step wherein said digital signal processor employs averaging algorithms to average a plurality of readings from one array, and wherein said digital signal processor employs averaging algorithms from a second array and wherein said averages are themselves averaged,
a digital signal baseline standardization step wherein a baseline calibration table is created from the measure of various mass air meters, said baseline calibration table is then stored in a digital signal processor creating an internal base line for all meters whereby differences is reading of various mass air meters due to variations in the manufacturing process are standardized.
a calibration table storage step wherein a plurality of said calibration tables are stored within the digital signal process, and wherein each calibration table is specific to an engine type,
a calibration table determination step wherein one or more of said plurality of calibration tables may be chosen for a particular engine type,
a dynamic range adjustment step wherein the dynamic range of input readings from the mass air sensor arrays may be adjusted so that the analog to digital converter may use the full voltage range for lower flow calibrations,
an output conversion step wherein digital mass air measures may be converted to analog outputs consisting of frequencies required by some engine control units or may be converted to analog outputs consisting of voltages required by other engine control units,

15. A method for measuring air mass intake of an engine according to claim 14 wherein a transition algorithm is employed whereby the time lag seen in the cooling of air mass sensors upon reading a sudden pulse of air is passed to the digital signal processor and consequently averaged, only if it exceeds a programmable threshold value.

16. A method for measuring air mass intake of an engine according to claim 14 wherein averaging and transition algorithms eliminate anomalous mass air readings.

17. A method for measuring air mass intake of an engine according to claim 14 wherein one or more of said plurality of calibration tables may be chosen for a particular engine type through input from an external programming device.

18. A method for measuring air mass intake of an engine according to claim 14 wherein one or more of said plurality of calibration tables may be chosen for a particular engine type through input from an onboard switch.

19. A method for measuring air mass intake of an engine according to claim 14 wherein said dynamic range adjustment step is programmable from an external programming device.
